(19) United States
(12) Patent Application Publication
(10) Pub. No.: US 2005/0149990 A1
(43) Pub. Date: Jul. 7, 2005

(54) Actuating selected Java Applets on a TV using a remote control

(76) Inventors: Jon A. Fairhurst, Camas, WA (US); Bryan S. Hallberg, Vancouver, WA (US); Mark G. Hanley, Skamania, WA (US); Vishnu Kumar, Vacouver, WA (US); Henry Y. Fang, Cerritos, CA (US); Jeffrey B. Sampsell, San Francisco, CA (US)

Correspondence Address: MARGER JOHNSON & MCCOLLOM, P.C. - SHARP, 1030 SW MORRISON STREET, PORTLAND, OR, 97205, US

(21) Appl. No.: 10/976,387

(22) Filed: Oct. 29, 2004

Related U.S. Application Data
(60) Provisional application No. 60/535,127, filed on Jan. 6, 2004.

(51) Int. Cl. H04N 7/16

(52) U.S. Cl. 725/136; 725/135; 725/139

(57) ABSTRACT

Java Applets are packaged in a JAR file, including accompanying classes and resources as well as one addition file—a descriptor file. This last file can be read from the JAR file, and scanned to extract an icon to represent the applet on a menu, the applet's name in market applicable languages, applet size and position, and the applets main class name. No further processing need be done to present this applet to the user for selection. The entire applet need not be loaded into memory until the user requests it by using a remote control to select one of the applets represented on the display by a labeled icon. Once the user has selected the application, the applet can be sized and launched without further scanning.

### CROSS-REFERENCES TO RELATED APPLICATIONS

This application claims the benefit from U.S. Provisional Patent Application No. 60/535,127 filed Jan. 6, 2004 whose contents are incorporated herein for all purposes.

### BACKGROUND OF THE INVENTION

1. Field of the Invention

The invention relates to interactive television systems, and more particularly to the methods for operating Java Applets on such televisions.

2. Description of the Prior Art

As embedded computers in televisions become more capable, it is inevitable that these computers will be called upon to host multiple applications. Whereas the first applications on computers embedded in televisions processed user input in managing TV settings (tradition menu and OSD), later applications will mimic the much broader base of functionality found in today's personal computers. The need is growing for users of future televisions to have access to multiple applications on their TV, and the ability to select and launch them from a standard menu.

There are several drawbacks to cost-effective modern televisions that would limit the ability of users to access available applications. First, TVs have limited processing power as compared to PCs. Second, TVs have limited memory as compared to PCs. Third, NTSC screen resolutions and the TV typical viewing distances will place a practical limitation of one (1) active application on the screen at a time. Fourth, hardware design changes will steer the language of choice for these applications to an interpreted language, such as Java. And fifth, given Java as a language and the limited nature of such a computer (see 1 & 2 above), the natural application framework becomes java.applet.Applet

Accordingly, the need remains for a method and system for accessing applets on televisions which addresses these drawbacks inherent in the prior art.

### SUMMARY OF THE INVENTION

In a preferred embodiment of the invention, Java Applets are packaged in a JAR file (characterized by a jar application extension) with all of the accompanying classes and auxiliary resources associated with applets and applications. An additional file is included as well: a descriptor file. This descriptor file can be read from the jar file, and scanned to extract an icon to represent: the applet on a menu, the applet's name in market applicable languages, the applet's size and icon display position, and the applets main class name.

An advantage of this approach is that no further processing need be done to present this applet to the user for selection (see assumption 1 above). Additionally, the entire applet need not be loaded into memory until the user requests it (see assumption 2 above). Accordingly, once the user has selected the application, the applet can be sized and launched without further scanning.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram showing a system for implementing a preferred embodiment of the invention.

FIG. 2 is a table showing a descriptor file for an applet implemented according to a first (C++) embodiment of the invention.

FIG. 3 is a table showing a descriptor file for an applet implemented according to a second (Java) embodiment of the invention.

FIG. 4 is a schematic diagram of a preferred remote control device used with the display of FIG. 1.

FIG. 5 is a screen image interface operable to launch applet programs on the television system of FIG. 1.

FIG. 6 is a screen image interface operable on the remote display of FIG. 1 to assign program function keys according to an alternate embodiment of the invention.

### DETAILED DESCRIPTION

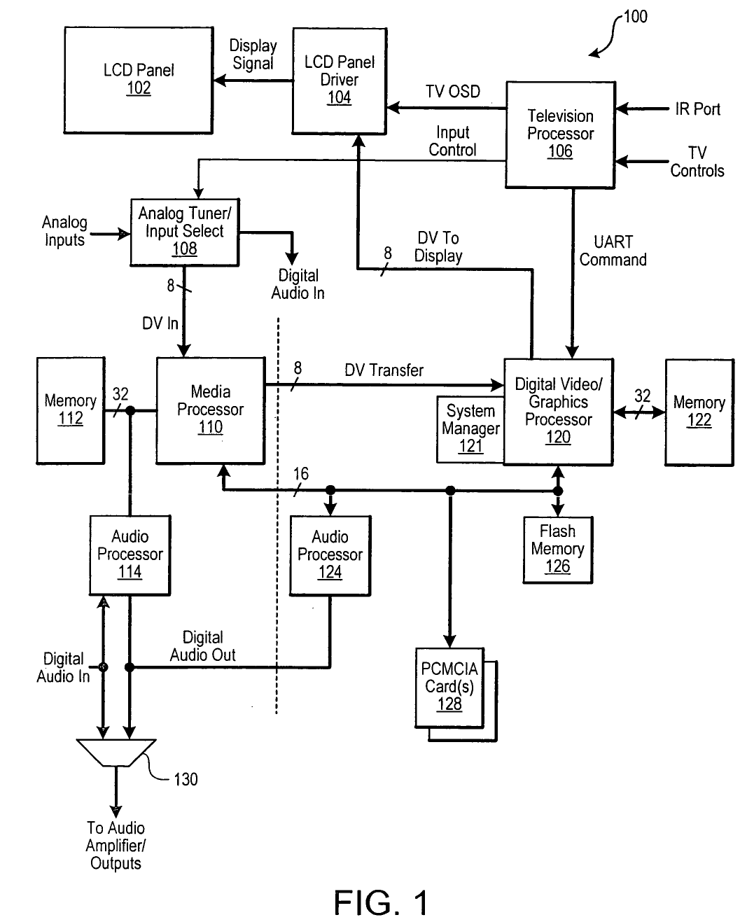

FIG. 1 contains a block diagram for a Liquid Crystal Display (LCD) television capable of operating according to some embodiments of the present invention. Television 100 contains an LCD panel 102 to display visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

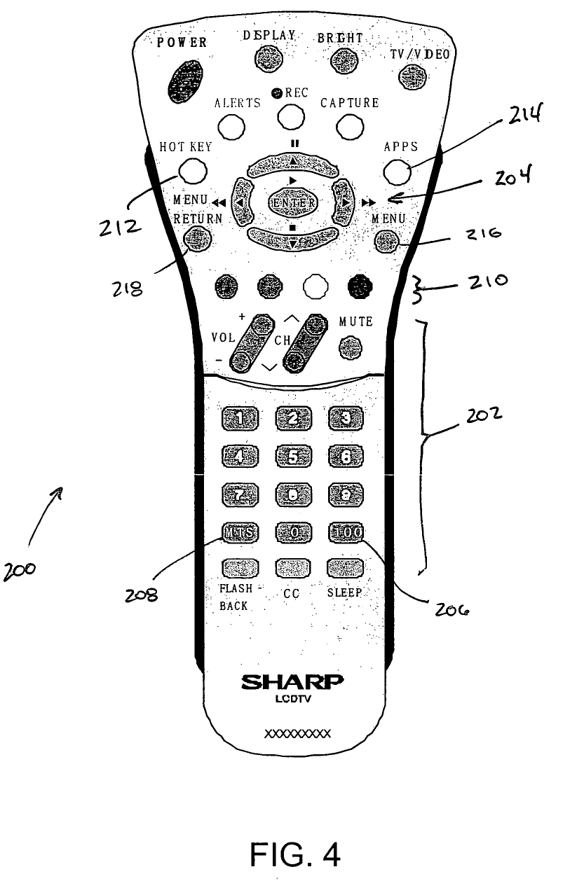

A television processor 106 provides basic control functions and viewer input interfaces for television 100. Television processor 106 receives viewer commands, both from buttons located on the television itself (TV controls) and from a handheld remote control unit (shown in FIG. 4 as remote 200) through the IR Port. Based on the viewer commands, television processor 106 controls an analog tuner/input select section 108, and also supplies user inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Digital video/graphics processor 120 includes the system manager 121, which will be explained in further detail below. Media processor 110 supplies digital video, either corresponding to DV In or to a decoded media stream from another source, to digital video/graphics processor 120 over a DV transfer bus.

Media processor 110 performs MPEG (Motion Picture Expert Group) coding and decoding of digital media streams for television 100, as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA cards 128. Flash memory 126 stores boot code, configuration data, executable code, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

The system is a dual processor ARM arrangement with the SystemManager running on both processors in a master/slave relationship, and the ApplicationManager running in the single JMV (Java Virtual Machine) on the Digital Video/Graphics Processor (master) ARM.

The System Manager is the portion of the C program responsible for launching all of the system tasks, including the codecs, the Java engine, and the Java Manager. The Java Manager engine executes the Java class code. The Java classes may be just in time compile, interpreted, precompiled, or of some other form.

The Java Manager is the only Java application running in the system implemented according to a preferred embodiment of the invention. The system may have multiple Applets, but only one Java application. The Java Manager, in the present system, contains the Application Manager (disclosed in greater detail below) and the Alert Manager and Hot Key Manager. Each of these managers comprise a class which are part of the Java Manager. They are not separate Applets.

The Application Manager is the class which locates all the available Java Applets, and displays the selections to the user on the GUI. When the user selects an Applet to run, the Application Manager calls the Java engine to launch the Applet.

In digital video/graphics processor 120, the system manager 121 is responsible for the basic operation of television 100, including locating and extracting the various applet files upon user request as described in more detail below. The applets may be stored for retrieval by the system manager 121 in various memory systems of television 100, including memory 112 and 122, or on PCMCIA cards 128.

According to embodiments of the invention, every program installed on the television system 100, whether a system service or Graphic User Interface (GUI) application program, has an associated program descriptor file. The program descriptor files provide the connection between programs installed on memory 112 or 122, flash memory 126, or PCMCIA cards 128 of the television system 100 and the system manager 121 residing on the digital video/graphics processor 120. The program descriptor file enables the system manager to locate the program's executable, privileges, process priority level, and other parameters necessary to incorporate the program into the television system 100.

Descriptor File Format

Program descriptor files are ASCII text files which can be created using any ASCII text editor. The file consists of a series of text lines. In a preferred implementation of the descriptor file, all lines must be present, and they must be in the required order to implement the preferred embodiment. The files' contents are case sensitive and are listed in Table 1.

TABLE 1
Descriptor File Contents

| Line | Label | Use |
|---|---|---|
| 1 | Executable_path: | program's executable path |
| 2 | Unfocused_icon_path: | program's GUI unfocused icon |
| | | path |
| 3 | Focused_icon_path: | program's GUI focused icon |
| | | path |
| 4 | Program_flags: | program's system flags |
| 5 | Interface_types: | program's interface types |
| 6 | System_interface: | program's system interface |
| 7 | Privileges: | program's privileges |
| 8 | Process_priority: | program's process priority |
| 9 | Private_key: | program's private security key |
| | | index |
| 10 | Public_key: | program's public security key |

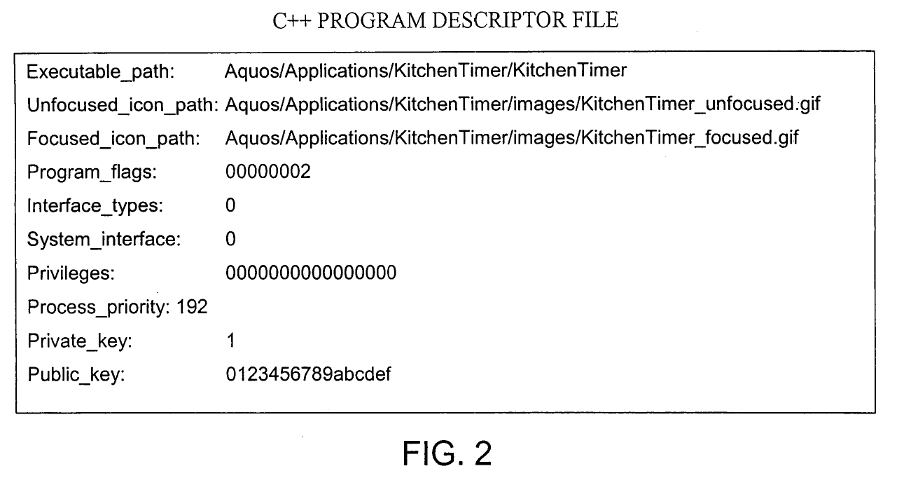

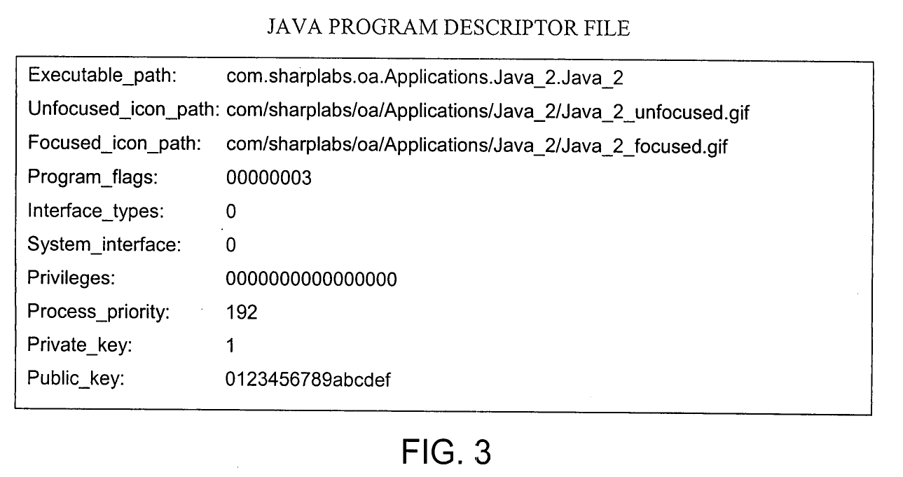

FIG. 2 is a table showing a descriptor file for an applet implemented according to some C+ embodiments of the invention. FIG. 3 is a table showing a descriptor file for an applet implemented according to some Java embodiments of the invention. The C+ descriptor file of FIG. 2 and the Java descriptor file of FIG. 3 are both formatted in keeping with Table 1 above.

Referring to Table 1, the program's system flags (line 4) and the program's interface types (line 5) may be defined in a header file (having a .h extension) that is separate from the program descriptor file. The values for the privileges line (line 7) may be defined in another header file (having a .h extension) that is separate from the program descriptor file. The interface types line contains the list of all interfaces supported by the program. In some embodiments of the invention, the last entry of the interface types line is zero (0).

The system manager 121 and associated graphic user interface, operable on television system 100, functions to present the user with all possible user selectable programs that the user may run, and enable the user to navigate through the programs and select and run their desired program. The user may also sort the program icons so that their favorite program icons are displayed first, allowing quick access to the user's favorite programs.

Preferred embodiments of the invention modify the <object> tag format for hyper-text markup language (html) as defined by Section 13.3 of HTML Specification 4.01, World Wide Web Consortium (W3C) Recommendation, 24 Dec. 1999, since that is a common launching pad for applets. HTML Specification 4.01 may presently be found at the following URL—http://www.w3.org/TR/html401/. Throughout the rest of this disclosure, the HTML 4.01 Specification will simply be referred to as HTML 4.01. HTML 4.01 is hereby incorporated by reference for all purposes.

From HTML 4.01:

TABLE 2
<Object> Tag Format

<!ELEMENT OBJECT — (PARAM | %flow;)*
— generic embedded object —>
<!ATTLIST OBJECT

| | | | |
|---|---|---|---|
| %attrs; | | | %coreattrs, %il8n, |
| | | | %events — |
| declare | (declare) | #IMPLIED | declare but don't |
| | | | instantiate |

flag
—

| | | | |
|---|---|---|---|
| classid | %URI; | #IMPLIED | identifies an imple- |
| | | | mentation — |
| codebase | %URI; | #IMPLIED | base URI for classid, |
| | | | data, |

archive —

| | | | |
|---|---|---|---|
| data | %URI; | #IMPLIED | reference to object's |
| | | | data — |
| type | % ContentType; | #IMPLIED | content type for |
| | | | data — |
| codetype | % ContentType; | #IMPLIED | content type for |
| | | | code — |
| archive | CDATA | #IMPLIED | space-separated list of |
| | | | URIs — |
| standby | %Text; | #IMPLIED | message to show while |
| | | | loading — |
| height | %Length; | #IMPLIED | override height — |
| width | %Length; | #IMPLIED | override width — |
| usemap | %URI; | #IMPLIED | use client-side image |
| | | | map — |
| name | CDATA | #IMPLIED | submit as part of |
| | | | form — |
| tabindex | NUMBER | #IMPLIED | position in tabbing |
| | | | order — |

>

Embodiments of the invention optimize the above <object> tag format based upon the embedded target environment. For example, the embedded target environment may be the television system 100 of FIG. 2. This optimization is accomplished by removing or ignoring some attributes that are deemed unnecessary for describing the associated program application, and adding other attributes that are considered useful for describing the associated program application.

As one example, the height and width attributes are retained, the classid attribute is simplified, and additional attributes are added. The added attributes include attributes x and y (which are implied in the placement of the <object> tag in html), an icon path attribute, and English, Spanish, and French attributes each containing a text string to name the applet in English, Spanish and French. The English, Spanish, and French attributes would be beneficial for television systems 100 that are destined for the North American market. Other similar features may be added depending on the local, regional, or continental markets where the television systems will be sold. The remaining attributes (from HTML 4.01) are deemed unnecessary and thereby removed or ignored.

The modified .jad (java application descriptor) according to the example embodiment described above would read as follows:

TABLE 3
Java Application Descriptor File

<object codetype=“application/java”

classid=“java:AMBApplet”
icon=“images\memo.gif”
english=“AudioMessageBoard”
espanol=“AMBApp [s]”
francais=“AMBApp [f]”
x=“0”
y=“0”
width=“640”
height=“480”>

</object>
</object>

Parameters may be added as per HTML 4.01 above. With this program descriptor file added to an applet (usually in a .jar, or java archive file), embodiments of the invention can scan this file, and extract just enough information to represent the applet to the user (icon and applet name). Then if the user wishes to invoke the applet, the rest of its extraction from the .jar file can occur per the normal class loading mechanism.

This .jad format has the advantage of being human readable, and relatively small in size. A speed optimized version is also available that is tailored for the Java class StringTokenizer.class which expects a character delimited string. This option removes most of the parsing, and so is faster, but suffers from a human readability standpoint. The modified .jad described above would appear as follows in “speed optimized” form:

TABLE 4
Speed-Optimized Descriptor File

AMBApplet;images\memo.gif;AudioMessageBoard;AMBApp[s] ;AMBApp[f] ;0;0;640;480

According to embodiments of the invention, the program descriptor files described above may be scanned by the system manager 121 to extract an icon to represent the applet on a menu screen, the applet's name in market applicable languages, the applet size and position, and the applets main class name. No further processing need be done to present this applet to the user for selection.

FIG. 4 shows one implementation of a remote control 200 used to implement the invention. The remote control in FIG. 4 includes many local-function buttons 202, examples of which are the number keys 0-9, the volume toggle button, and the channel toggle button. The remote control further has plurality of non-local function keys and cursor buttons 204 (up, down, right, left, enter) to browse through on-screen displays as described further below. Each key, when depressed, activates a wireless signal (here an infrared signal) to be transmitted from the remote control. Each button activates a separate wireless signal. The television display includes a wireless receiver (“IR Port” in FIG. 1) and interpreter which compares the signal with a table of functions and matches the signal received with the function requested. The requested function (e.g. raise or lower volume) is then carried out (as by routing more or less power to the speaker amplifiers). Such functions are well known in the art and not described further.

UI Screen Design

The Application Manger Graphical User Interface (AMGUI) program's initial screen is displayed when the user presses the <Apps> button 214 of the remote control of FIG. 4. The system manager scans the descriptor files and extracts the icon and applet name to display to the user. In the descriptor file shown in Table 3, for instance, the icon image stored at images\memo.gif is retrieved and displayed with the “AudioMessageBoard” label on television display 102. Program icons are displayed in the order of the user's favorite program list, with programs not in the list being displayed last. Each screen of icons except the last screen displays nine icons. The last screen displays however many icons remain, with a maximum number of nine. Icon file paths are read from the program's descriptor file. The currently selected program has its highlighted icon displayed, while the remaining programs have their normal icons displayed.

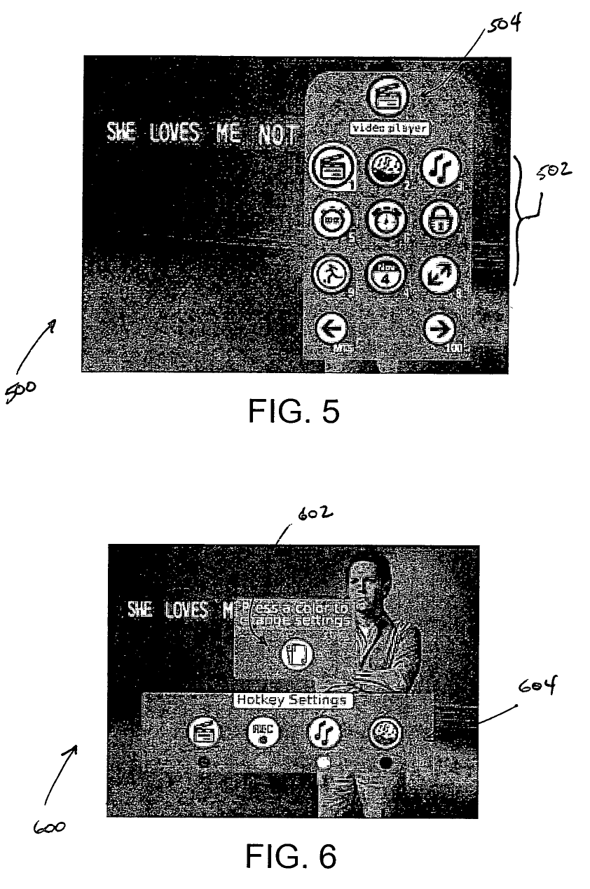

FIG. 5 shows a screen 500 of icons when at least nine programs are user selectable. If fewer than nine programs were available, then less than nine icons 502 would be displayed. The user navigates through the icons using the remote control cursor buttons 204, with the currently selected program being indicated by having its highlighted icon displayed and labeled in an upper screen section 504. The user can select the program by pressing the remote control's <Enter> button while the desired program's icon is highlighted.

Each program icon has a number placed over it, starting with number 1 at the upper left icon and ending at number 9 at the lower right icon. The user may immediately select a program without navigating to it by simply pressing the remote control number button 202 indicated by the number placed over the desired program's icon.

The user may select the next screen of programs by pressing the remote control's <100> button 206, and the previous screen of programs by pressing the <MTS> button 208. The user may also navigate to the next screen by pressing the <Right Arrow> button while the lower left icon is highlighted, or by pressing the <Down Arrow> button of cursor buttons 204 while any bottom row icon is highlighted. Similarly, the user may navigate to the previous screen by pressing the <Left Arrow> button while the lower upper right icon is highlighted, or by pressing the <Up Arrow> button while any top row icon is highlighted.

Certain keys of the remote control may be assigned certain functions. In the example described below, colored keys 210 are assigned (or re-assigned) certain program functions using a hotkey activator button 212. These colored keys 210 are also referred to as “hotkeys” because, and according to methods of the invention, they each trigger operation of certain programs that have been associated with the button (or more precisely, the remote control signal triggered by pressing the hotkey button).

Hot keys 210 are assigned to a particular function by first navigating to that function using whatever method is normally used to access the function, then pressing the <Hotkey> button 212 to request a hot key assignment, and then pressing the desired hot key to which the function will be assigned. The table of wireless signals received and functions performed that is stored at the television is updated to point to the new function. Any previous function which was already assigned to that button will no longer be assigned to the button. Only one function can be assigned to any one button, however, more than one button can have the same function assigned to it.

Hot keys are assigned to start a program via the Application Manager GUI (AMGUI). To assign a function, the user first enters the AMGUI by pressing the <[Apps]> button 214, then navigates to the desired program's icon and presses the <Hotkey> button 212. After pressing the <Hotkey> button, the hot key button screen 600 appears, as shown in FIG. 6. The screen shows the icon 602 for the program currently being assigned to a hot key near the top of the screen. The current hot key assignment icons 604 are shown lower on the screen, with each hot key's currently assigned program or function icon displayed above a bar the color of the icon's assigned hot key. The user assigns the new program to a hot key by pressing the desired colored hot key 210—red, green, yellow, or blue. The user can press <Hotkey> button 212 to leave the hot key screen of FIG. 6, or any other OA key that brings up a different screen, i.e. <[Apps]> 214, <Menu> 216, or <Return> 218. After pressing the desired hot key 210, the hot key screen disappears and the function is now assigned to the pressed hot key signal.

Hot keys are assigned to program functions similarly to the method used to assign them to programs. The user navigates through the desired program and highlights the desired function. The user then presses the <Hotkey> button 212 and assigns the hot key 210 as described in the previous paragraph. If a program does not support a hot key for the desired function, a message is displayed on display 100 stating “Hot Key Not Supported,” to inform the user that the desired function does not support hot keys.

Having described and illustrated the principles of the invention in a preferred embodiment thereof, it should be apparent that the invention could be modified in arrangement and detail without departing from such principles. We claim all modifications and variation coming within the spirit and scope of the following claims.

1. A system for activating and displaying an application on a display comprising:
a display;
a display processor operating the display;
memory coupled to the display processor having one or more application files stored thereon, each application file having associated therewith a descriptor file;
a system manager operable on the display processor and adapted to scan the descriptor file responsive to user request and display an icon on the display associated with the descriptor file;
a selection input device coupled to the display and adapted to receive user selections thereon of the displayed icon,
wherein responsive to user selection of the displayed icon, scanning the application file associated with the descriptor file associated with the selected icon.

2. The system of claim 1, the selection input device being characterized by a wireless remote control having defined thereon one or more buttons, each of said buttons operable to activate a unique wireless transmission signal when pressed; and
a wireless receiver in electronic communication with the remote display and adapted to receive the unique wireless transmission signals from the wireless transmission device.

3. The system of claim 3, further including a hotkey manager program operable on the display processor and adapted to assign program functions to the one or more buttons.

4. The system of claim 1, the descriptor file including a series of attributes listed in a required order.

5. The system of claim 4, wherein attributes program system flags and program interface types are defined in a header file that is separate from the program descriptor file.

6. The system of claim 4, wherein attribute values for a privileges line are defined in another header file that is separate from the program descriptor file.

7. The system of claim 4, wherein a last entry of an interface types attribute line is zero (0).

8. The system of claim 4, wherein attributes of the descriptor file include height and width attributes, a simplified classid attribute, x- and y-placement attributes, an icon path attribute, and foreign language attributes each containing a text string to name the applet in that foreign language.

9. The system of claim 1, wherein the descriptor file is listed in a character delimited string.

10. A method for launching an applet on a television system display, comprising:
associating a descriptor file with the applet, said descriptor file including a plurality of attributes;
responsive to a user request, extracting the descriptor file and displaying a visual cue representative of the extracted descriptor file on the display; and
responsive to selection by the user of the visual cue, invoking the applet associated with the descriptor file.

11. The method of claim 10, further including the step of displaying a plurality of visual cues corresponding to a plurality of descriptor files and selecting among the plurality of visual cues using a remote control device.

12. The method of claim 10, wherein the step of extracting the descriptor file includes first extracting only a portion of the descriptor file prior to user selection of the visual cue and only after selection of the visual cue extracting the remainder of the descriptor file.

13. The method of claim 12, wherein the step of extracting only a portion of the descriptor file prior to user selection of the visual cue includes extracting an icon to represent the applet on a menu screen, the applet's name in market applicable languages, the applet size and position, and the applets main class name.

14. The method of claim 10, the descriptor file including a series of attributes listed in a required order.

15. The method of claim 14, wherein attributes program system flags and program interface types are defined in a header file that is separate from the program descriptor file.

16. The method of claim 14, wherein attribute values for a privileges line are defined in another header file that is separate from the program descriptor file.

17. The method of claim 14, wherein a last entry of an interface types attribute line is zero (0).

18. The method of claim 14, wherein attributes of the descriptor file include height and width attributes, a simplified classid attribute, x- and y-placement attributes, an icon path attribute, and foreign language attributes each containing a text string to name the applet in that foreign language.

19. The method of claim 10, wherein the descriptor file is listed in a character delimited string.

20. The method of claim 10, further including the steps of removing or ignoring attributes listed in the descriptor file that are deemed unnecessary for describing the associated applet, and adding other attributes that are considered useful for describing the associated applet.
